(19) United States
(12) Patent Application Publication
(10) Pub. No.: US 2005/0141571 A1
(43) Pub. Date: Jun. 30, 2005

(54) Coherent tuning apparatus for optical communication device

(76) Inventors: Sahnggi Park, Daejeon-Shi (KR); Moon Ho Park, Daejeon-Shi (KR); Ki Soo Kim, Jeollabuk-Do (KR); Su Hwan Oh, Daejeon-Shi (KR); Ji Myon Lee, Daejeon-Shi (KR); Chul Wook Lee, Daejeon-Shi (KR)

Correspondence Address: JACOBSON HOLMAN PLLC, 400 SEVENTH STREET N.W., SUITE 600, WASHINGTON, DC, 20004, US

(21) Appl. No.: 10/923,834

(22) Filed: Aug. 24, 2004

(30) Foreign Application Priority Data
Dec. 26, 2003 (KR) 2003-97057

(51) Int. Cl. H01S 3/10

(52) U.S. Cl. 372/20

(57) ABSTRACT

Provided is a coherent tuning apparatus capable of continuously tuning wavelength of light over a wide band of wavelength at high speed and outputting high power, the apparatus including an optical waveguide through which spatially coherent light passes, an electrode array for changing a direction of the light passing through the optical waveguide by applying electric field or current to a portion of the optical waveguide, and a wavelength selection optical element unit for selecting a specific wavelength of the light.

### BACKGROUND

1. Field of the Invention

The present invention relates to a coherent tuning apparatus widely applicable to optical communication devices.

2. Discussion of Related Art

As huge amount of information has created since 80's, a demand for large network communication capacity, which requires many channels assigned over a wide range of frequency, is explosively grown. Wavelength tunable devices are key components in many applications such as wavelength division multiplexing (WDM) and packet switching architecture. Such network communication capacity depends on the number of frequencies which are accessible by wavelength tunable lasers. Accordingly, the wavelength tunable devices capable of tuning light over a wide wavelength range are needed.

The present application discloses a wavelength tunable semiconductor laser which is a key component of the wavelength tunable devices.

Expanding the wavelength tunable range of a semiconductor laser has been an important research field for several ten years so far. Such researches have been focused on integration structures capable of acquiring wavelength tunability by electrical effects instead of thermal effects which are late with respect to the electrical effects, and devices with a predictable tuning algorithm.

The wavelength tunable semiconductor lasers are generally realized in two different ways of monolithic and non-monolithic integration.

Non-monolithic wavelength tunable semiconductor lasers adopt a way of a wavelength tunable solid state laser or a die laser which comprises an active material and a wavelength tunable filter in a cavity. An external cavity of the non-monolithic semiconductor laser comprises a facet mirror in the semiconductor section at one end and a diffraction grating at the other end. A light beam travels between the facet mirror and the diffraction grating through the antireflection-coated semiconductor facet. The diffraction grating changes its angle for tuning the wavelength of the light beam. The external cavity semiconductor laser provides a tuning range of more than 100 nm and outputs powers of several miliwatts.

However, such a semiconductor laser with the external cavity should abandon many advantages of conventional semiconductor lasers such as high speed of wavelength tuning, small size, mass-productivity, low cost and high degree of integration. Thus, development for the monolithic semiconductor laser is strongly motivated from the drawbacks of the non-monolithic semiconductor laser.

Distributed feed-back (DFB) lasers and distributed bragg reflector (DBR) lasers are examples of monolithic wavelength tunable semiconductor lasers. The DBR lasers and multi-section DFB wavelength tunable lasers have a limited wavelength tunable range which is less than 10 nm due to the limit of refractive index ratio, Δn/n. Accordingly, a new wavelength tuning scheme is required to expand the wavelength tunable range beyond the limit of refractive index ratio.

In early 90's, a lot of research groups had reported promising wavelength tuning schemes. Out of the many schemes, one is a Y-cavity laser accomplished by simple modification of Mach-Zender interferometer. The Y-cavity laser has advantages that it provides a tunable range of 38 nm and does not have a grating section, so its fabrication process is simple. However, the Y-cavity laser has a critical drawback that it has 15 to 20 dB of low side mode suppression ratio (SMSR).

The other one is a laser device with an intra-cavity grating-assisted co-directional coupler (GACC) filter. The tunable range of this device depends on Δ μ(μ₁-μ₂) rather than Δ μ/μ, where μ₁ and μ₂ are effective indices of refration of two optical waveguides which are coupled together. This laser device provides about 57nm of tunable range by reducing a value of μ₁-μ₂. However, reduction of the value, μ₁-μ₂, raises a problem of degrading the side mode suppression ratio. Furthermore, the GACC filter has a very narrow design window to acquire allowable SMSR.

To date, the most promising commercialized device is disclosed in U.S. Pat. No. 4,896,325 and is a semiconductor laser using periodically sampled grating DBR (SGDBR). The sampled grating provides periodical reflection peaks in wavelength spectrum. Tuning is accomplished by moving the reflection peaks of two sampled gratings which have slightly different periods.

Even though the SGDBR laser has many advantages in comparison with other tuning schemes, it has a critical problem. Wavelength tuning is not continuous, but quasi-continuous. In other words, moving from one wavelength to another is very complicate and time-consuming. Users can use only wavelengths tabled by laser manufacturers.

A Superstructure Grating DBR laser disclosed in U.S. Pat. No. 5,325,325 is a slight modification of the SGDBR laser, and uses chirped gratings instead of the sampled gratings to generate the periodical reflection peaks. The superstructure grating DBR laser does not only take the complicate tuning procedure which has the same problem as SGDBR laser, but its manufacturing process is also complicate and difficult by requiring E-beam lithography.

### SUMMARY OF THE INVENTION

In view of the above-mentioned problems, the prevent invention is directed to a new wavelength tuning scheme capable of continuously tuning wavelengths over a wide wavelength range and applicable to optical communication devices.

The present invention is also directed to a coherent tuning apparatus with synergy effects of non-monolithic and monolithic semiconductor lasers, thereby being manufactured according to a simple and easy manufacturing method.

One aspect of the present invention is to provide an apparatus for coherent tuning, comprising an optical waveguide through which spatially coherent light beams pass, an electrode array for changing a direction of the light passing the optical waveguide by applying electric field or current to a portion of the optical waveguide, and a wavelength selection optical element unit for selecting a wavelength of the light.

The term “wavelength selection optical element unit” means an optical device operating by selecting a wavelength out of a plurality of wavelengths of light and includes a wavelength tunable filter, a wavelength tunable modulator and a wavelength tunable switch.

The electrode array includes a plurality of electrodes, and each electrode has an incident angle of the light and an exit angle of the light, wherein the incident angle is different from the exit angle. Further, the refractive index in the inside of each electrode is different from that in the outside of the electrode when electric field or current is applied thereto.

Here, the coherent tuning apparatus is not limitedly applied to a specific device but widely applied to optical communication devices using an optical waveguide formed of optical fibers, semiconductors, dielectrics and polymers. For example, the coherent tuning apparatus can be applied to an optical waveguide formed of a dielectric such as LiNbO₃ and an optical fiber of silica.

Another aspect of the present invention is to provide an apparatus for coherent tuning, comprising an optical waveguide through which spatially coherent light passes, an active area formed on a portion of the optical waveguide for generating an optical signal, an electrode array for changing a direction of the light passing through the optical waveguide by applying electric field or current to a portion of the optical waveguide, and a DBR mirror for selecting a certain wavelength of the light with the direction changed by the electrode array.

### BRIEF DESCRIPTION OF THE DRAWINGS

The purpose and advantages of the present invention will be more apparent by describing in detail exemplary embodiments thereof with reference to the attached drawings in which:

FIG. 1 is a schematic diagram of a DBR semiconductor laser with a coherent tuning apparatus in accordance with an exemplary embodiment of the present invention;

FIG. 2 illustrates examples of electrodes of the coherent tuning apparatus in FIG. 1;

FIG. 3A is a microscopic photograph of a semiconductor laser with a coherent tuning function, which is manufactured as a sample;

FIG. 3B is an enlarged view of an electrode array in the microscopic photograph of FIG. 3A; and

FIGS. 4A, 4B and 4C are tuning spectrum results of a semiconductor laser with a coherent tuning function, which is manufactured as a sample.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

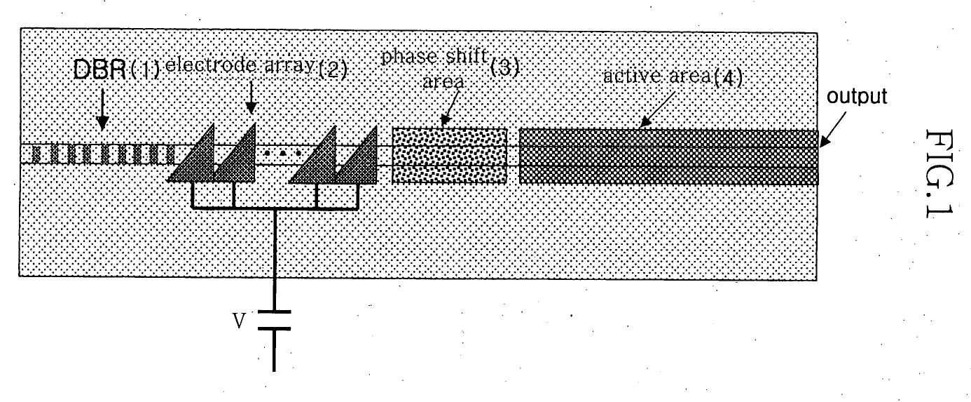

FIG. 1 illustrates a schematic diagram of a semiconductor laser with a coherent tuning apparatus in accordance with one embodiment of the present invention. Conventional DBR lasers have a tuning electrode on a DBR, but the coherent tunable DBR semiconductor laser shown in FIG. 1 has a tuning electrode between a DBR and a phase shift area or a section of an active area.

Referring to FIG. 1, the DBR semiconductor laser with a coherent tuning function in accordance with the present invention is composed of a DBR mirror 1, an electrode array 2, a phase shift area 3 and an active area 4.

The DBR 1 is realized in a diffraction grating structure on the upper surface or the lower surface of an optical waveguide. The diffraction grating acts as a reflective mirror, thereby constituting a resonator. The DBR 1 can be manufactured by various conventional methods well known in the art.

The electrode array 2 continuously changes a direction of a light beams passing through the optical waveguide formed in a cavity by applying electric field or current to the optical waveguide. For example, in order to change the refractive index of a core of the optical waveguide through which the light beam passes, the electrode array 2 and a ground electrode are installed above and under the optical waveguide, respectively, and potential difference is applied between the electrode array 2 and the ground electrode.

That is, an angle of light incident to one electrode, i.e. a triangle, of the electrode array 2 is different from an exit angle of the light and the refractive index in the inside of the triangle is different from that in the outside of the triangle when the electric field or current is applied. Under the same condition, the direction of the light beam will be continuously changed little by little. The electrode array 2 can be a triangle, a trapezoid or any polygons with two sides which are not parallel. This will be described in more detail later. However, when the electrode array 2 has a structure to which the above principle is applied, the shape can be variously deformed.

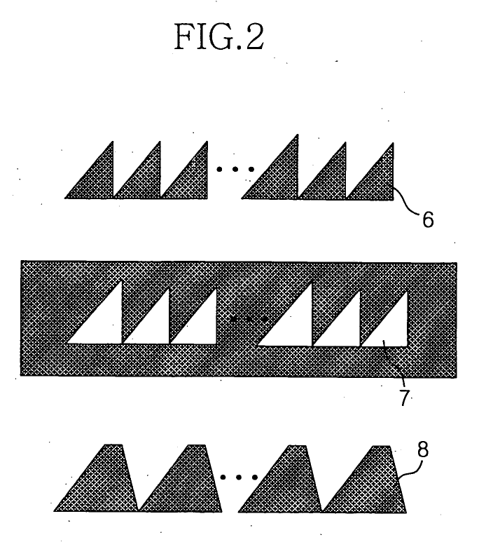

FIG. 2 illustrates examples of the electrode array. A first exemplary electrode is a triangular shape, a second one is a reversed triangular shape and a third one is a trapezoidal shape. The first and second exemplary electrodes refract light beams to the opposite directions. The electrodes can be a triangle, a trapezoid and other polygons. The electrodes with polygon shapes other than triangles are in the range of this invention.

On the other hand, given that an optical waveguide comprises a core layer formed of InGaAsP with refractivity, n=3.359, and a cladding layer formed of InP, the peak of a change of a refractive index at the highest current is about 0.516%=(1558 nm-1500 nm)/1500 nm. Further, if the light is incident on a triangular electrode with a right angle and exit it with an angle of 45°, then the angle of propagation of the light is changed as much as Δ Θ=0.2965° whenever the light beam passes one electrode of the electrode array.

The active area 4, the phase shift area 3 and the output mirror (not shown) are elements conventionally well known in the art. Accordingly, a detailed description of the active area 4, the phase shift area 3 and the output mirror may be omitted for convenience's sake. The phase shift area 3 finely adjusts to meet a resonant condition of a cavity for wavelength tuning but it is not an essential element.

Next, the principle of the coherent tunable DBR semiconductor laser in accordance with one embodiment of the present invention will be described below in detail. If electric field or current is applied to an electrode array, a wave vector of coherent laser light is changed due to a shape of an electrode of the electrode array.

In the present invention, the wavelength tuning is accomplished by using an optical waveguide and spatial coherence of the light.

When spatially coherent light passes through the optical waveguide, the wavefront of the light maintains a constant phase in the waveguide and the light propagates as a plane wave. In the case that a force is applied to bend the direction of the light by an angle of Θ, an actual propagation direction of the light is not changed due to the waveguide but the wave vector of the light is changed as much as k, k=kₒ cos λ, where kₒ is a component of an initial wave vector. If the light is coherent spatially, then the refracted angle is accumulated by all the electrodes which can produce a large change of wave vector.

If the light passing through the waveguide is not coherent, or coherent length of the light is too short, then the magnitude of wave vector is not actually changed when the light passes a plurality of electrodes because the refracted angle is not accumulated and averaged out to zero which results in no average change of wave vector.

When light with the wave vector which is changed by cos Θ passes a DBR mirror or a Febry-Perot filter on the waveguide, wavelength of the reflected or transmitted light is changed as much as cos Θ, by λ=λ cos Θ. In the case that the wave vector which is changed as much as cos Θ on the waveguide is not relaxed for a sufficient length, i.e. for the total length of the tuning electrodes and DBR mirror, the wavelength tuning can be accomplished as much as cos Θ.

In the straight waveguide, in the case that a loss of the evanescent field is not greatly larger than that of the electric field in a core layer, the increased evanescent field may be maintained for a sufficient length. That is, the relaxation length can be very long and it is ensured in experiments described below.

Accordingly, in the case that coherent light such as laser light passes a waveguide, the wavelength tuning is accomplished by changing the wave vector in combination with a wavelength selective mirror or a filter. To acquire a wide range of wavelength tuning, the wave vector should be changed by the corresponding amount to the wavelength tuning range. The large amount of the wave vector change can be achieved by repeatedly changing an angle of a propagation direction of the light for the number of times which is needed.

A linear change of the wave vector, which is accomplished by repeatedly changing the angle of the propagation direction of the light, is possible for only coherent light. A principle of the coherent tuning is suggested by inventors of this invention for the first time and assured by experiments.

Generally, in the case of considering a change of a refractive index of a DBR laser in a waveguide layer, one triangular electrode in FIG. 1 can change the direction of the wave vector by 0.3° and 0.06° by current and electric field, respectively, at most. Accordingly, in the case of using the current for tuning, at least 41 electrodes are needed to tune the whole c-band, 35 nm. If electric field is used for wavelength tuning, at least 203 electrodes are needed. Even though the electrodes of the electrode array are triangles, distribution of applied current or electric field can be differed from the shape of the electrodes due to diffusion while the current passes through a waveguide layer. Accordingly, theoretically calculated wavelength tunable range per one electrode is very small. This will be described in detail below.

To use the current for wavelength tuning, ion implantation process may be used so as for injected carrier to maintain the same shape as the electrode in a waveguide layer. On the other hand, to use electric field, the electrodes should be properly designed.

Further, theoretical limitation to break maximum tunable range is relaxation of the wave vector. That is, a large relaxation length should be obtained for the given wave guide, a semiconductor waveguide. If the relaxation length is smaller than a size of the electrode or a period of the DBR, the wavelength tuning is impossible. In the experiments conducted by the inventors of this application, it is ensured that the relaxation length is sufficiently long to render the wavelength tuning possible.

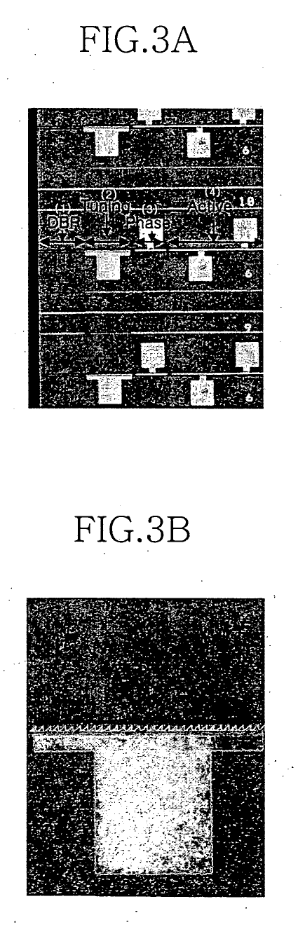

FIG. 3A illustrates a microscopic photograph of a coherent tuning semiconductor laser which is actually manufactured, and FIG. 3B is an enlarged view of a part of the photograph of FIG. 3A.

The coherent tuning semiconductor laser shown in FIG. 3A is manufactured according to the following steps. First, on an n-InP substrate, an n-InP buffer layer is formed to a thickness of about 3000 Å, and an active layer for an optical waveguide and a multiple quantum well active layer are sequentially deposited on the buffer layer. The optical waveguide is a mono-layer formed of a quaternary such as InGaAsP and has a thickness of 2000 to 4000 Å. The active layer has a multiple quantum well structure and is formed of a quaternary such as InGaAsP. The thickness of the active layer is about 2000 to 4000 Å, too. Next, the active layer and the optical waveguide are patterned in turn by applying a lithography process and an etching process to the active layer.

Next, after an InP of P-cladding layer and a P-InGaAs of ohmic layer are deposited, an isolation process is performed to isolate the electrode array and the active area. Then, Pi/Pt/Au layers are formed to thicknesses of 200/200/3000 Å, respectively, and patterned to form metal electrodes. The metal electrodes are formed on the electrode array, the active area and the phase shift area. The electrode array can be made of various metals but is preferably formed of an Au layer with a thickness of about 100 to 200 nm. The electrode can be an arrangement of triangular electrodes.

The sizes of the active area, the phase shift area, the DBR and the electrode array were 500 μm, 1501 μm, 374 μm and 2251 μm, respectively, and the electrode array was formed of 32 triangular electrodes.

### COMPARATIVE EXAMPLES

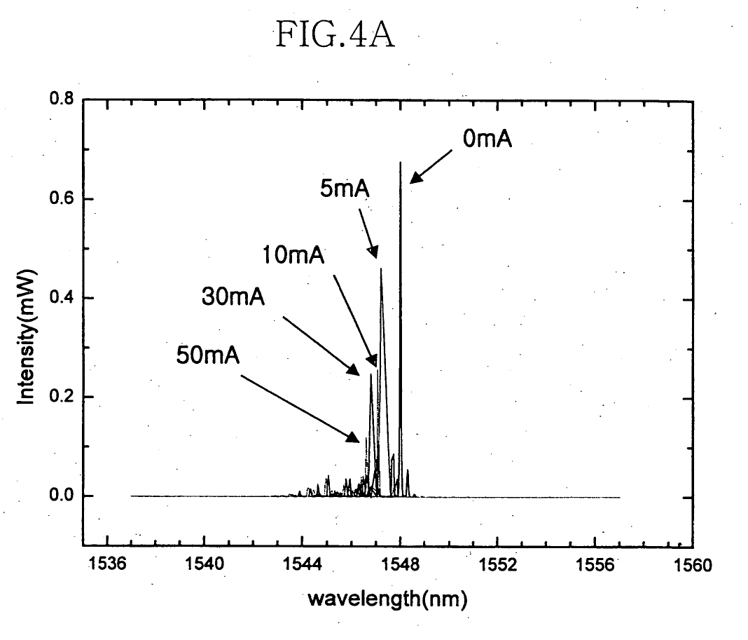

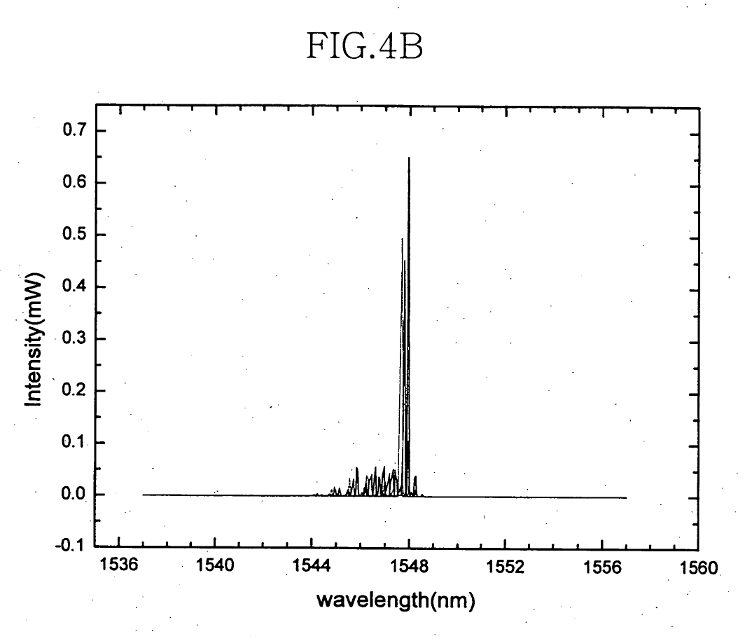

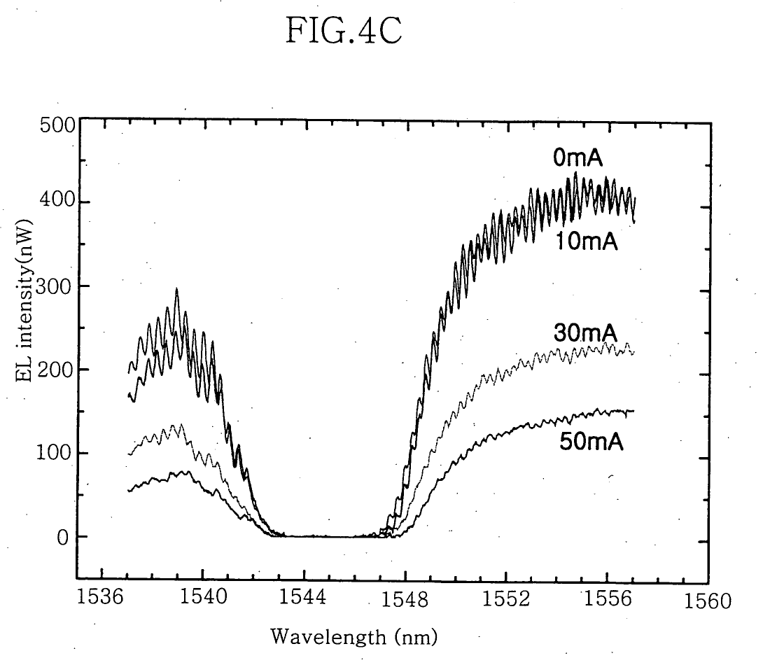

FIGS. 4A, 4B and 4C illustrate tuning spectrum results of the coherent semiconductor laser manufactured in accordance with the method described above.

FIG. 4A is a graph showing a result of wavelength tuning which is acquired by changing current in a tuning section with injecting 120 mA of current to the active area. Current was not applied to the phase area. 1.4 nm of wavelength tuning or 2.4° change of wave vector was observed while changing the current applied to the electrode array from 0 mA to 50 mA. A calculation shows that 2.4° is reasonably close to the difference between the critical angle and the fundamental mode angle for our waveguide. Using the beam propagation modeling program, BeamProp Ver. 6.0, our waveguide structure has confinement factors of 0.2156 and 0.65 in vertical and horizontal directions, respectively, which give a total confinement factor, 0.14 and effective index difference, Δ=0.03. The critical angle is, then, calculated as 82.15°. The mode angles are obtained from the equation, 2πndcos θ/λ-φ(θ)=mπ, where n, d, m are a refractive index of core, a width of the waveguide, and an integer, respectively, and φ(θ) is a phase change at total internal reflection. The graphical solution of this equation shows the mode angle of 85.6° for the fundamental mode angle with our waveguide structure, d=2 μm, n=3.20, λ=1550 nm. Therefore, the theoretical value is 3.45° which is reasonably larger than the value, 2.4° obtained from FIG. 4A. As expected, high loss at critical angle will stop lasing so that only some amount of smaller value is allowable. Furthermore, as the waveguide is not designed specially in this experiment, we believe that the refracted light propagates more as a leaky mode than the fundamental guiding mode, which can make serious limits on laser characteristics as well as the tuning range.

FIG. 4B illustrates a graph which is observed by changing current of the phase area without applying current to the electrode array under the same condition as FIG. 3. Laser peaks are jumped within the range of, at most, two longitudinal modes, which is very typical in DBR lasers. The current injection into phase section excludes any possibility of tuning by a change of carrier density in waveguides.

FIG. 4C illustrates a graph which is observed by applying current of 15 mA smaller than threshold current, 17 mA, of the laser to the active area and changing current of the tuning area. At this time, the current was not applied to the phase area. FIG. 4C shows a luminescence spectrum of the active area and a stop band of the DBR mirror. Luminescence has a short coherent length smaller than several μms and is considered incoherent. Nothing shifts at all by a distinguishable amount. That is, coherent tuning was possible for only coherent light.

Current injection of 5 mA induces 2 nm tuning at the DBR laser that we fabricated with the same materials and structures as FIG. 1 except the tuning electrode that is located on the DBR mirror and its net area on waveguide, 390 μm². It means the refractive index change, Δn=0.00413 at the current density, 12.82 μA/μm². The net area of triangular electrodes on the waveguide is 256 μm² which gives a refractive index change of 0.00629 with assumption of linear index change near the current. A refraction angle by a single triangle is, then, 0.1125°. At least, 16 electrodes are needed to get the total refraction angle of 1.84°. Considering diffusion of carriers, we may expect much more electrodes to be involved. This calculation proves not only the accumulative change of angle but also the distance before k-vector relaxation longer than several hundred micrometers, at least. We believe that the most serious problems in extending the tuning range are the diffusion of carriers that prevents an index change at a particular area and the design of waveguide to make the refracted wave propagate as a fundamental guiding mode.

Even though the range of wavelength tuning was small as much as 1.4 nm, a coherent tuning theory was proved by the experiments. Even though the coherent tuning was applied to semiconductor lasers in the experiments, it can be further applied to all devices with a waveguide and a wavelength selection area designed to meet the coherent theory suggested by the inventors.

Although the exemplary embodiment of the present invention have been disclosed for illustrative purpose, those skilled in the art will appreciate that various modifications, additions and substitutions are possible, without departing from the scope and spirit of the invention as disclosed in the accompanying claims.

1. Apparatus for coherent tuning comprising:
an optical waveguide through which spatially coherent light passes;
an electrode array for changing a direction of propagation of the light passing through the optical waveguide by applying electric field or current to a portion of the optical waveguide; and
a wavelength selection optical element unit for selecting a specific wavelength of the light.

2. The apparatus as set forth in claim 1, wherein the wavelength selection optical element unit is any one of a wavelength tunable filter, a wavelength tunable modulator, and a wavelength tunable switch.

3. The apparatus as set forth in claim 1, wherein the optical waveguide is formed of any one of a semiconductor, a dielectric, and a polymer.

4. The apparatus as set forth in claim 1, wherein the electrode array comprises a plurality of electrodes, in which an incident angle of the light is different from an exit angle of the light for each electrode and the refractive index in the inside of the electrode is different from that in the outside when the electric field or current is applied to the electrode.

5. The apparatus as set forth in claim 1, wherein each electrode is any one of a triangle and a trapezoid.

6. Apparatus for coherent tuning comprising:
an optical waveguide through which spatially coherent light passes;
an active area formed on a portion of the optical waveguide for generating an optical signal;
an electrode array for changing a direction of propagation of the light passing through the optical waveguide by applying electric field or current to a portion of the optical waveguide; and
a distributed bragg reflector (DBR) mirror for selecting a specific wavelength of the light changed by the electrode array.

7. The apparatus as set forth in claim 6, further comprising a phase control circuit provided at a side of the active area.

8. The apparatus as set forth in 6, wherein the optical waveguide is formed of any one of a semiconductor, a dielectric, and a polymer.

9. The apparatus as set forth in claim 6, wherein the electrode array comprises a plurality of electrodes, in which an incident angle of the light is different from an exit angle of the light for each electrode and the refractive index in the inside of the electrode is different from that in the outside when the electric field or current is applied to the electrode.

10. The apparatus as set forth in claim 6, wherein each electrode is any one of a triangle and a trapezoid.
